(19) United States
(12) Patent Application Publication
(10) Pub. No.: US 2023/0147523 A1
(43) Pub. Date: May 11, 2023

(54) MULTIFUNCTIONAL MASSAGE HEAD FOR FASCIAL GUN AND FASCIAL GUN

(71) Applicant: Zhejiang Jinbang Sports Equipment Co., Ltd., Zhejiang (CN)

(72) Inventors: Yongqiang XU, Zhejiang (CN); Zhiyun SONG, Zhejiang (CN)

(73) Assignee: Zhejiang Jinbang Sports Equipment Co., Ltd., Zhejiang (CN)

(21) Appl. No.: 17/918,575

(22) PCT Filed: Feb. 23, 2021
(86) PCT No.: PCT/CN2021/077340

§ 371 Date: Oct. 13, 2022

(30) Foreign Application Priority Data
Dec. 3, 2020 (CN) 202011413469.X

(51) Int. Cl. A61H 23/00

(52) U.S. Cl. CPC A61H 23/006; A61H 2201/0107

(57) ABSTRACT

A multifunctional massage head of a fascial gun and the fascial gun are provided. The multifunctional massage head of the fascial gun includes a base block and a plurality of massage head bodies in different shapes, the massage head bodies are arranged on the base block, and the base block is provided with a plurality of first connecting holes. The first connecting holes are in one-to-one correspondence to the massage head bodies, and the first connecting holes are coaxial with the corresponding massage head bodies.

### BACKGROUND

### Technical Field

The present application relates to the technical field of massage heads, in particular to a fascial gun and a multifunctional massage head of the fascial gun.

### Description of Related Art

A fascial gun is fully called a muscle and fascia relaxing massage gun. The fascial gun relieves muscle spasm, increases blood flow and greatly shortens muscle recovery time by utilizing vibration frequency. The fascial gun may be used for relieving muscle fatigue caused after exercise, and the relieving effect may last for a long time.

At present, most products on the markets have different functions, a plurality of massage heads are provided, different massage heads may massage different parts or muscle tissues of the body, for example, circular massage heads are suitable for massaging large muscle groups such as arms, the waist and back, the hip, thighs and shanks, and U-shaped massage heads are suitable for massaging the neck, the spine and the Achilles tendon. The multiple massage heads are independent of one another, and are very inconvenient to store and troublesome to take.

### SUMMARY

In order to solve the technical problems, the present application provides a fascial gun and a multifunctional massage head of the fascial gun, and a plurality of massage head bodies of different types are integrated, and are simple and compact in structure and convenient to store and use.

In order to solve the problems, the present application is achieved by adopting the following technical solutions.

A multifunctional massage head of a fascial gun comprises a base block and a plurality of massage head bodies in different shapes.

The massage head bodies are arranged on the base block.

The base block is provided with a plurality of first connecting holes.

The first connecting holes are in one-to-one correspondence to the massage head bodies, and the first connecting holes are coaxial with the corresponding massage head bodies.

In the scheme, the plurality of massage head bodies in different shapes are arranged on the base block, when a certain massage head body is needed, the first connecting hole corresponding to the massage head body is connected to the fascial gun by means of a connecting rod, at the moment, the massage head body faces forwards. The central axis of each first connecting hole and the central axis of the corresponding massage head body are located on the same straight line, and it can be ensured that the massage head bodies corresponding to the first connecting holes of the fascial gun move synchronously along with a piston rod of the fascial gun.

Preferably, the massage head bodies comprise a U-shaped massage head body, a cylindrical massage head body, a flat massage head body, a shove-shaped massage head body or a tower-shaped massage head body.

Preferably, the base block is spherical.

Preferably, the multiple massage head bodies comprise a first massage head body and a second massage head body, and an axis of the first massage head body and an axis of the second massage head body are intersected at a center of sphere of the base block.

Preferably, the plurality of massage head bodies further comprise a third massage head body, an axis of the third massage head body penetrates through the center of sphere of the base block and is perpendicular to the axis of the first massage head body and the axis of the second massage head body. When used, the third massage head body may not be interfered by the first massage head body and the second massage head body.

Preferably, an included angle between the axis of the first massage head body and the axis of the second massage head body is 120 degrees. Thus, the first massage head body and the second massage head body do not interfere with each other when used.

Preferably, a part of a spherical surface of the base block is a massage surface, the axis of the massage surface penetrates through the center of sphere of the base block, the axis of the massage surface, the axis of the first massage head body and the axis of the second massage head body are located on a same plane, an included angle between the axis of the massage surface and the axis of the first massage head body is 120 degrees, an included angle between the axis of the massage surface and the axis of the second massage head body is 120 degrees, the base block is further provided with a second connecting hole coaxial with the massage surface, and the second connecting hole and the first connecting holes have same shapes and size.

The massage surface, the first massage head body and the second massage head body do not interfere with one another when used. The base block is spherical, and a part of the spherical surface of the base block is a massage surface, namely, the base block is also equivalent to a spherical massage head body.

Preferably, the multifunctional massage head of a fascial gun further comprises a connecting rod, and the connecting rod comprises a first cylinder matched with the first connecting holes, a second cylinder configured to be matched with a through hole formed in a front end of a piston rod at a muzzle of the fascial gun.

The connecting rod includes the first cylinder and the second cylinder. The first cylinder is used for being inserted into one first connecting hole to be in clamped connection with the first connecting hole, and the second cylinder is used for being inserted into the through hole formed in the front end of the piston rod at the muzzle of the fascial gun, and is in clamped connection with the through hole formed in the front end of the piston rod. By the connecting rod, the multifunctional massage head of a fascial gun can be matched with existing universal fascial guns on the markets.

Preferably, a first rubber ring is sleeved on the first cylinder, and a second rubber ring is sleeved on the second cylinder. The first rubber ring is used for increasing force of friction between the first cylinder and the first connecting hole, and the second rubber ring is used for increasing force of friction between the second cylinder and the through hole formed in the front end of the piston rod.

A fascial gun disclosed by the present application comprises the multifunctional massage head of a fascial gun, and a joint pin matched with the first connecting holes is arranged at the front end of the piston rod at the muzzle of the fascial gun.

The piston rod is in clamped connection with one first connecting hole by means of the joint pin at the front end of the piston rod, and thus, the piston rod does not need to be connected to one first connecting hole by means of the connecting rod.

The present application has the beneficial effects that: the multiple massage head bodies of different types are integrated, and are simple and compact in structure and convenient to store and use.

### BRIEF DESCRIPTION OF THE DRAWINGS

FIG. 1 is a structure diagram of an embodiment 1;

FIG. 2 is a top view of FIG. 1;

FIG. 3 is a bottom view of FIG. 1;

FIG. 4 is a rear view of FIG. 1;

FIG. 5 is a right view of FIG. 1;

FIG. 6 is a structure diagram of a connecting rod;

FIG. 7 is a structure diagram of a piston rod;

FIG. 8 is a top view of FIG. 7;

FIG. 9 is a structure diagram of an embodiment 2;

FIG. 10 is a top view of FIG. 9;

FIG. 11 is a bottom view of FIG. 9;

FIG. 12 is a rear view of FIG. 9; and

FIG. 13 is a left view of FIG. 9.

In Figures: 1-base block, 2-first connecting hole, 3-first massage head body, 4-second massage head body, 5-third massage head body, 6-massage surface, 7-second connecting hole, 8-first cylinder, 9-second cylinder, 10-first rubber ring, 11-second rubber ring, 12-piston rod, 13-joint pin, and 14-mounting hole.

### DESCRIPTION OF THE EMBODIMENTS

The technical solution of the present application is further specifically described below by way of embodiments in conjunction with the accompanying drawings.

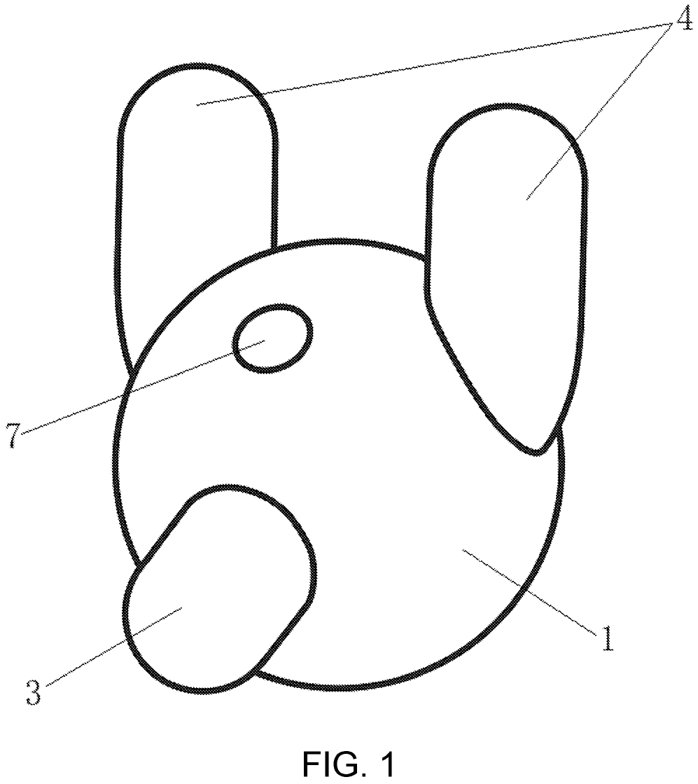

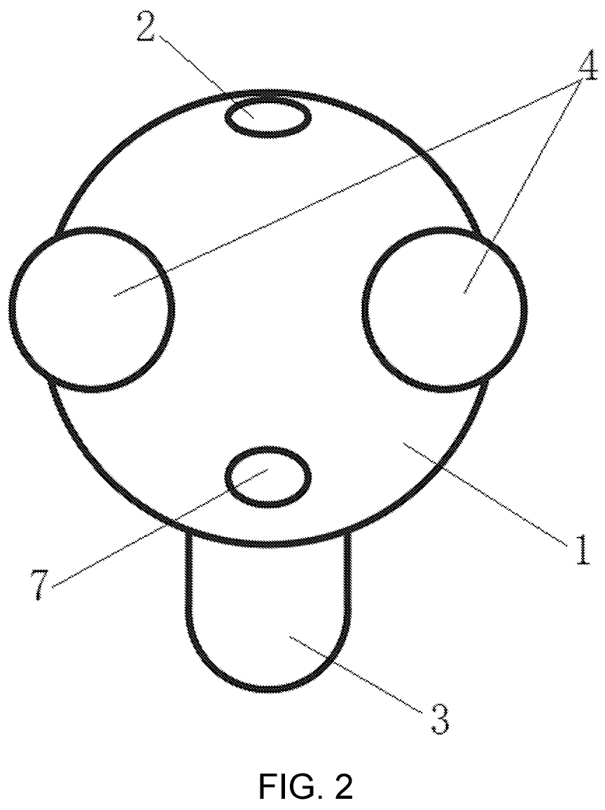

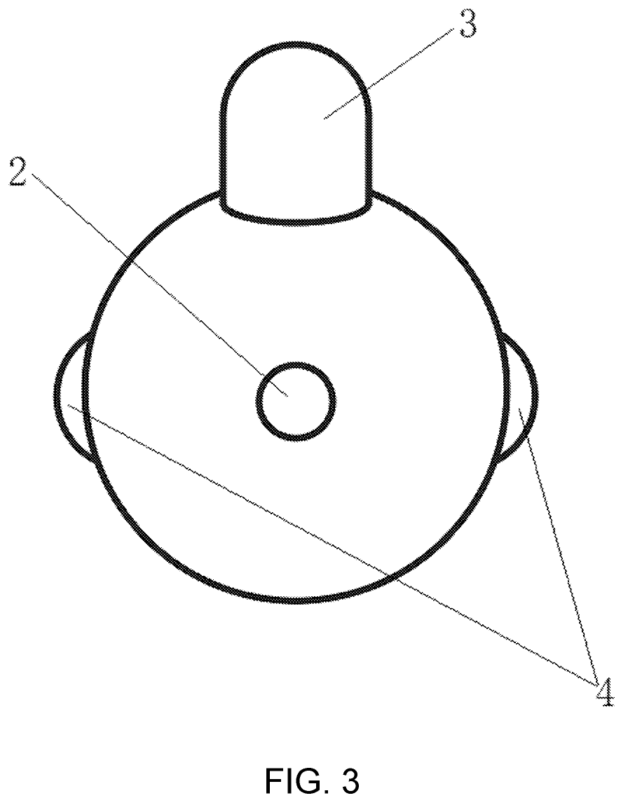

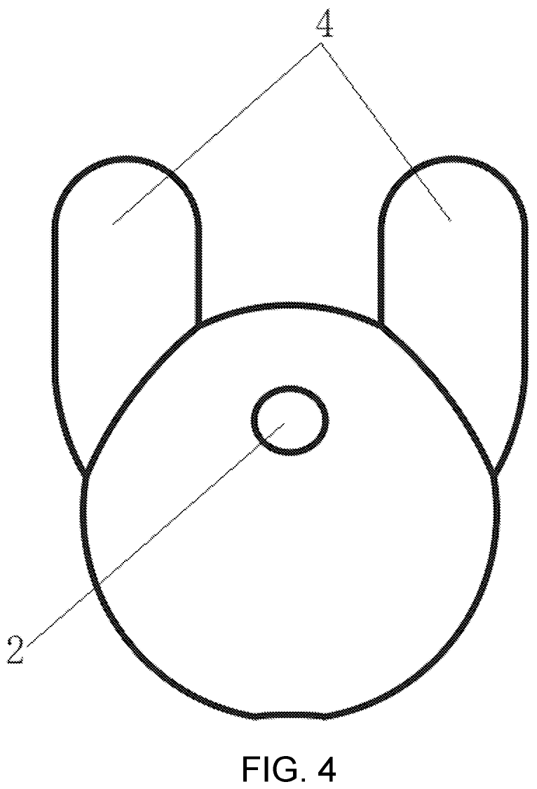

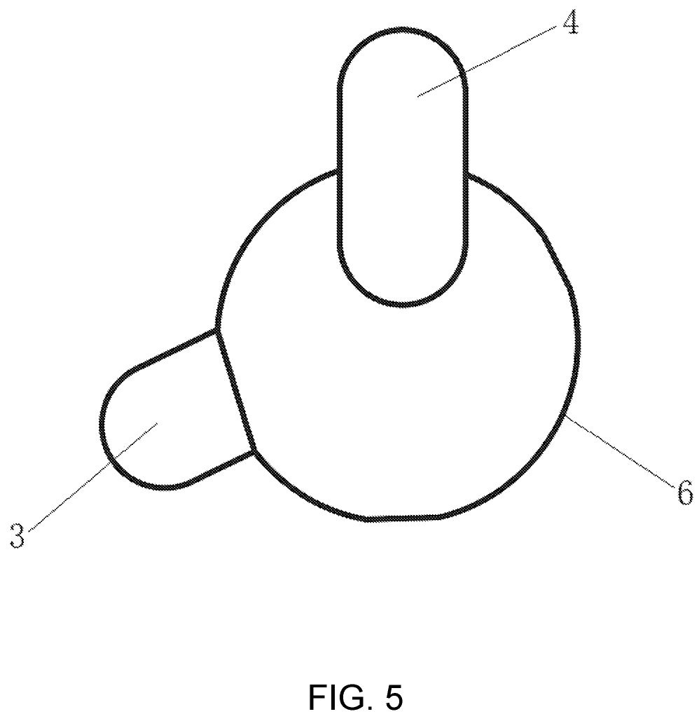

Embodiment 1. A multifunctional massage head of a fascial gun in the present embodiment, as shown in FIG. 1, FIG. 2, FIG. 3, FIG. 4 and FIG. 5, comprises a base block 1 and two massage head bodies in different shapes.

The massage head bodies are arranged on the base block 1.

The base block 1 is provided with two first connecting holes 2.

The first connecting holes 2 are in one-to-one correspondence to the massage head bodies, and the first connecting holes 2 are coaxial with the corresponding massage head bodies.

The base block 1 is spherical, the two massage head bodies comprise a first massage head body 3 and a second massage head body 4. The first massage head body 3 is a cylindrical massage head body, and the second massage head body 4 is a U-shaped massage head body. A part of the spherical surface of the base block 1 is a massage surface 6. The axis of the first massage head 3, the axis of the second massage head 4 and the axis of the massage surface 6 are intersected at the center of sphere of the base block 1, the axis of the first massage head body 3, and the axis of the second massage head body 4 and the axis of the massage surface 6 are located on the same plane. An included angle between the axis of the first massage head body 3 and the axis of the second massage head body 4 is 120 degrees, an included angle between the axis of the massage surface 6 and the axis of the first massage head body 3 is 120 degrees, and an included angle between the axis of the massage surface 6 and the axis of the second massage head body 4 is 120 degrees. The base block 1 is further provided with a second connecting hole 7 which is coaxial with the massage surface 6, and the shape and size of the second connecting hole 7 are the same as those of the first connecting holes 2.

In the scheme, the massage head bodies in different shapes are arranged on the base block, the base block is also provided with the massage surface. When the massage surface or a certain massage head body is used, the second connecting hole or the first connecting hole corresponding to the massage head body are connected to the fascial gun by means of the connecting rod, and at the moment, the massage surface or the massage head faces forwards. The base block is spherical, a part of the spherical surface of the base block is the massage surface, namely, the base block is also equivalent to a spherical massage head body.

The central axis of each first connecting hole and the central axis of the corresponding massage head body are located on the same straight line, the central axis of the second connecting hole and the central axis of the massage surface are located on the same straight line, and it can be ensured that the used massage surface or massage head body can move synchronously along with the piston rod of the fascial gun. The included angles among the axis of the massage surface, the axis of the first massage head body and the axis of the second massage head body are 120 degrees, so that the massage surface, the first massage head body and the second massage head body do not interfere with one another when used.

The first massage head body and the second massage head body may both be any of a U-shaped massage head body, a cylindrical massage head body, a flat massage head body, a shovel-shaped massage head body or a tower-shaped massage head body. The shape and size of the second connecting hole are the same as those of the first connecting holes, so that the second connecting hole and the first connecting holes can be matched with the same connecting rod.

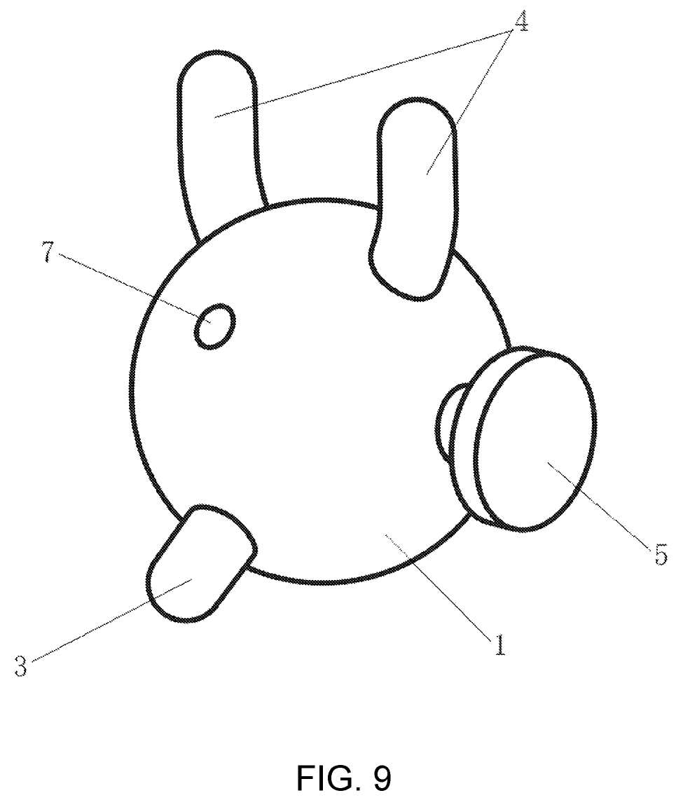

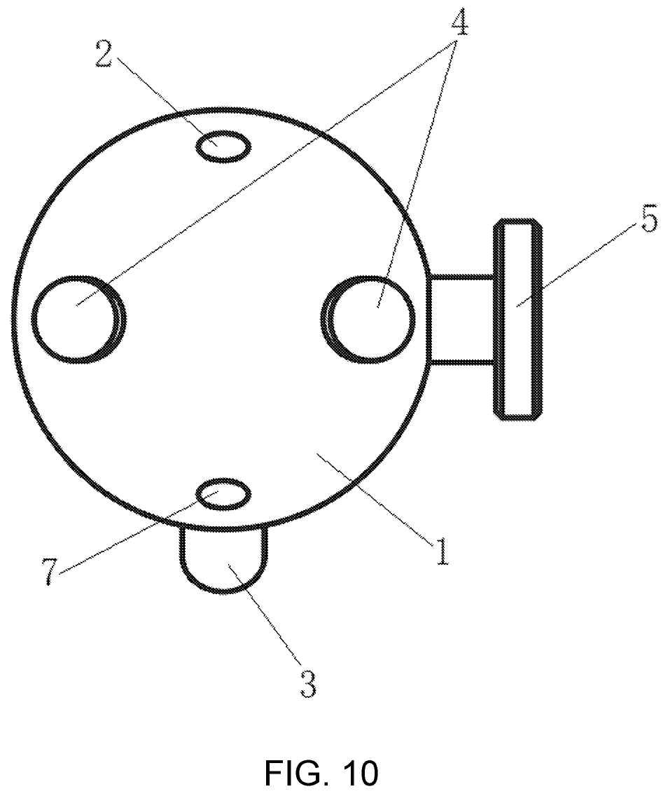

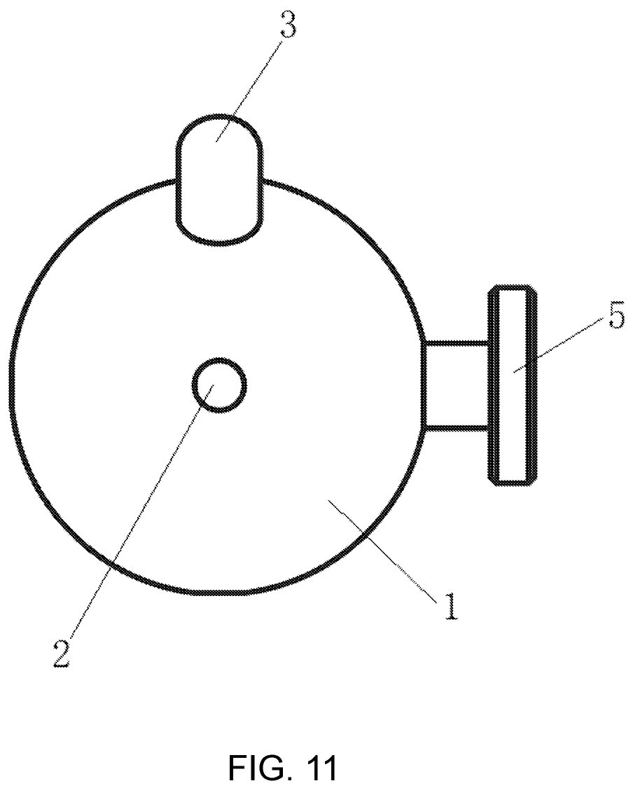

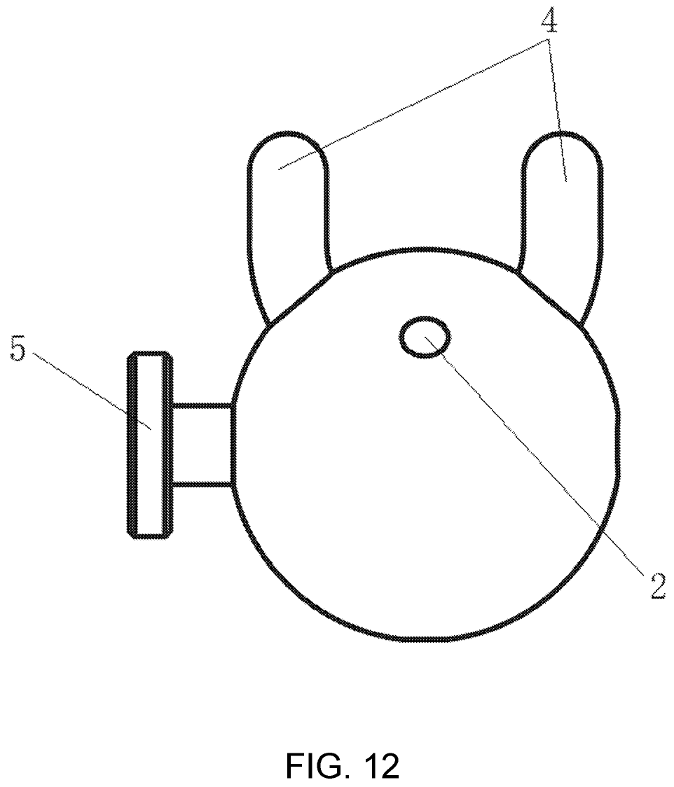

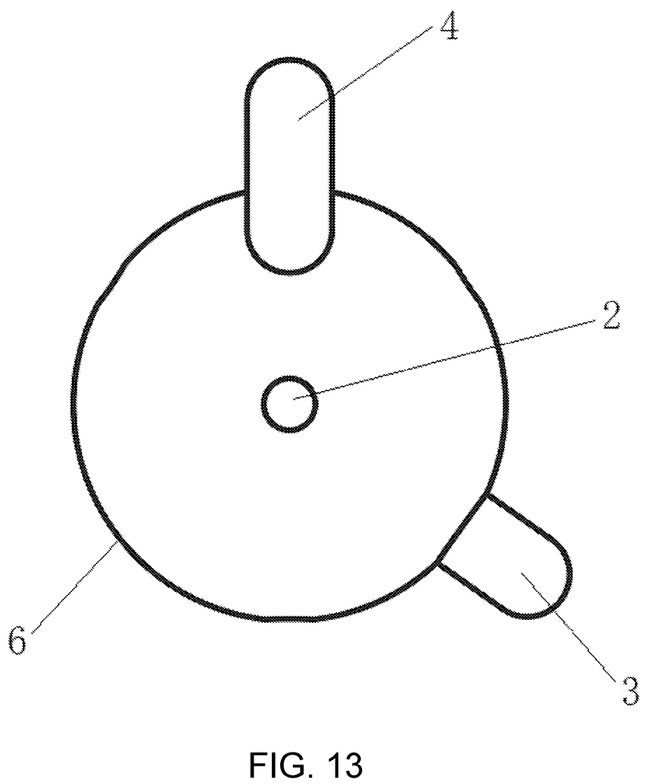

Embodiment 2. A multifunctional massage head of a fascial gun in the present embodiment, as shown in FIG. 9, FIG. 10, FIG. 11, FIG. 12 and FIG. 13, comprises a base block 1 and three massage head bodies in different shapes.

The massage head bodies are arranged on the base block 1.

The base block 1 is provided with three first connecting holes 2.

The first connecting holes 2 are in one-to-one correspondence to the massage head bodies, and the first connecting holes 2 are coaxial with the corresponding massage head bodies.

The base block 1 is spherical, the three massage head bodies comprise a first massage head body 3, a second massage head body 4 and a third massage head body 5. The first massage head body 3 is a cylindrical massage head body, the second massage head body 4 is a U-shaped massage head body, and the third massage head body 5 is a flat massage head body. A part of the spherical surface of the base block 1 is a massage surface 6, the axis of the first massage head body 3, the axis of the second massage head body 4 and the axis of the massage surface 6 are intersected at the center of sphere of the base block 1, the axis of the first massage head body 3, and the axis of the second massage head body 4 and the axis of the massage surface 6 are located on the same plane. An included angle between the axis of the first massage head body 3 and the axis of the second massage head body 4 is 120 degrees, an included angle between the axis of the massage surface 6 and the axis of the first massage head body 3 is 120 degrees, and an included angle between the axis of the massage surface 6 and the axis of the second massage head body 4 is also 120 degrees. The base block 1 is further provided with a second connecting hole 7 coaxial with the massage surface 6, the shape and size of the second connecting hole 7 are the same as those of the first connecting holes 2, and the axis of the third massage head body 5 penetrates through the center of sphere of the base block 1 and is perpendicular to the axis of the first massage head body 3 and the axis of the second massage head body 4.

In the scheme, the three massage head bodies in different shapes are arranged on the base block, the base block is also provided with the massage surface, when the massage surface or a certain massage head body is needed, the second connecting hole or the first connecting hole corresponding to the massage head body is connected to the fascial gun by means of the connecting rod, at the moment, the massage surface or the massage head body faces forwards. The base block is spherical, and a part of the spherical surface of the base block is the massage surface, namely, the base block is equivalent to a spherical massage head body.

The central axis of the first connecting hole and the central axis of the corresponding massage head body are located on the same straight line, the central axis of the second connecting hole and the central axis of the massage surface are located on the same straight line, and it can be ensured that the used massage surface or used massage head body can move synchronously along with the piston rod of the fascial gun. The included angles among the axis of the massage surface, the axis of the first massage head body and the axis of the second massage head body are 120 degrees, and the axis of the third massage head body is perpendicular to the axis of the first massage head body and the axis of the second massage head body, so that the massage surface, the first massage head body, the second massage head body and the third massage head body do not interfere with one another when used.

The first massage head body, the second massage head body and the third massage head body may be any of a U-shaped massage head body, a cylindrical massage head body, a flat massage head body, a shove-shaped massage head body or a tower-shaped massage head body. The shape and size of the second connecting hole are the same as those of the first connecting holes, so that the second connecting hole and the first connecting holes can be matched with the same connecting rod.

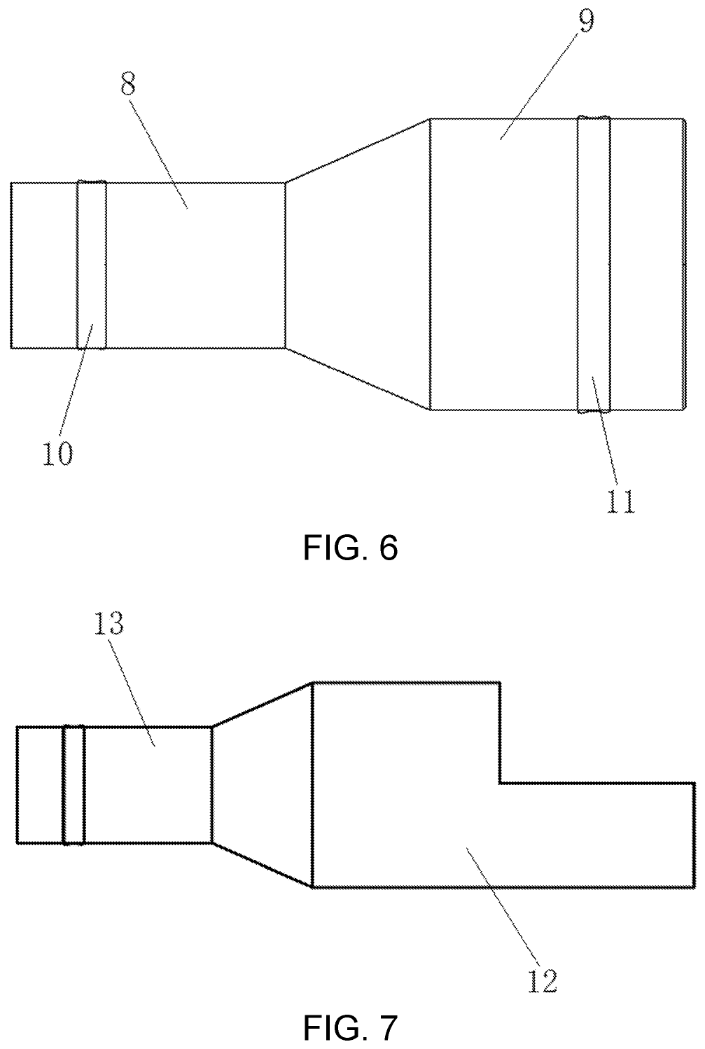

Embodiment 3. A multifunctional massage head of a fascial gun in the present embodiment, on the basis of the multifunctional massage head of a fascial gun in the embodiment 1 or the embodiment 2 and as shown in FIG. 6, further comprises a connecting rod. The connecting rod comprises a first cylinder 8 matched with the first connecting holes 2, and a second cylinder 9 matched with a through hole formed in the front end of a piston rod at a muzzle of the fascial gun, a first rubber ring 10 is sleeved on the first cylinder 8, and a second rubber ring 11 is sleeved on the second cylinder 9.

In the scheme, the connecting rod includes the first cylinder and the second cylinder. The first cylinder is used for being inserted into one first connecting hole to be in clamped connection with the first connecting hole, and the second cylinder is used for being inserted into the through hole formed in the front end of the piston rod at the muzzle of the fascial gun and is in clamped connection with the through hole of the front end of the piston rod. Because the shape and size of the second connecting hole are the same as those of the first connecting holes, the first cylinder can also be in clamped connection with the second connecting hole. By means of the connecting rod, the multifunctional massage head of a fascial gun can be matched with existing universal fascial gun on the markets.

The first rubber ring is used for increasing force of friction between the first cylinder and the first connecting holes and force of friction between the first cylinder and the second connecting hole, and the second rubber ring is used for increasing force of friction between the second cylinder and the through hole formed in the front end of the piston rod.

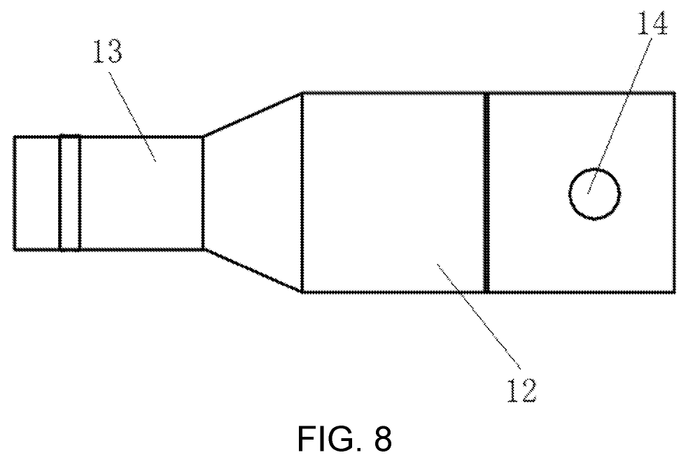

Embodiment 4. A fascial gun in the present embodiment, comprises a multifunctional massage head of a fascial gun in the embodiment 1 or the embodiment 2, and as shown in FIG. 7 and FIG. 8, a joint pin 13 matched with the first connecting holes 2 is arranged at the front end of the piston rod 12 at the muzzle of the fascial gun. A planar nozzle is formed in the rear end of the piston rod 12, and the planar notch is provided with a mounting hole 14.

In the scheme, the piston rod is fixedly connected to the driving mechanism of the fascial gun through the mounting hole. The joint pin can be in clamped connection with one first connecting hole, and because the shape and size of the second connecting hole are the same as those of the first connecting holes, the joint pin can also be in clamped connection with the second connecting hole.

The piston rod is directly in clamped connection with the first connecting holes and the second connecting hole by means of the joint pin at the front end of the piston rod, and thus, the piston rod does not need to be connected to the first connecting holes and the second connecting hole by means of the connecting rod. The piston rod performs piston motion under driving of the driving mechanism, and the multifunctional massage head of a fascial gun is driven to perform reciprocating motion.

1. A multifunctional massage head of a fascial gun the multifunctional massage head comprising: a base block and a plurality of massage head bodies in different shapes;
wherein the massage head bodies are arranged on the base block;
the base block is provided with a plurality of first connecting holes; and
the first connecting holes are in one-to-one correspondence to the massage head bodies, and the first connecting holes are coaxial with the corresponding massage head bodies.

2. The multifunctional massage head of the fascial gun according to claim 1, wherein the massage head bodies comprise a U-shaped massage head body, a cylindrical massage head body, a flat massage head body, a shovel-shaped massage head body or a tower-shaped massage head body.

3. The multifunctional massage head of the fascial gun according to claim 1, wherein the base block is spherical.

4. The multifunctional massage head of the fascial gun according to claim 3 wherein the plurality of massage head bodies comprise a first massage head body and a second massage head body , and an axis of the first massage head body and an axis of the second massage head body are intersected at a center of sphere of the base block.

5. The multifunctional massage head of the fascial gun according to claim 4, wherein the multiple massage head bodies further comprise a third massage head body , an axis of the third massage head body penetrates through the center of sphere of the base block , and is perpendicular to the axis of the first massage head body and the axis of the second massage head body .

6. The multifunctional massage head of the fascial gun according to claim 4, wherein an included angle between the axis of the first massage head body and the axis of the second massage head body is 120 degrees.

7. The multifunctional massage head of the fascial gun according to claim 6, wherein a part of a spherical surface of the base block is a massage surface, an axis of the massage surface penetrates through the center of sphere of the base block , the axis of the massage surface, the axis of the first massage head body and the axis of the second massage head body are located on a same plane, an included angle between the axis of the massage surface and the axis of the first massage head body is 120 degrees, an included angle between the axis of the massage surface and the axis of the second massage head body is 120 degrees, the base block is further provided with a second connecting hole which is coaxial with the massage surface, and the second connecting hole and the first connecting holes have same shape and size.

8. The multifunctional massage head of the fascial gun according to claim 1, the multifunctional massage head further comprising: a connecting rod, wherein the connecting rod comprises a first cylinder matched with the first connecting holes, and a second cylinder configured to be matched with a through hole formed in a front end of a piston rod at a muzzle of the fascial gun.

9. The multifunctional massage head of the fascial gun according to claim 8, wherein a first rubber ring is sleeved on the first cylinder , and a second rubber ring is sleeved on the second cylinder .

10. A fascial gun,comprising the multifunctional massage head of the fascial gun according to claim 1, wherein a joint pin matched with one of the first connecting holes is arranged at a front end of a piston rod at a muzzle of the fascial gun.
